(19) United States
(12) Patent Application Publication
(10) Pub. No.: US 2007/0224444 A1
(43) Pub. Date: Sep. 27, 2007

(54) Plating film and forming method thereof

(75) Inventor: Seiki Sakuyama, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/475,169

(22) Filed: Jun. 27, 2006

(30) Foreign Application Priority Data
Mar. 24, 2006 (JP) 2006-083074

(51) Int. Cl. C25D 3/30; B32B 15/01

(52) U.S. Cl. 428/646; 205/300; 428/457

(57) ABSTRACT

Tin plating film composed of tin or tin alloy is formed on a front surface and a rear surface of a substrate composing a lead frame. As tin alloy, for example, tin-copper alloy (content of copper: 2 mass %), tin-bismuth alloy (content of bismuth: 2 mass %) and the like can be cited. The substrate is composed of, for example, Cu alloy or the like. Within the tin plating film, plural crystal grains are arranged irregularly. Further, plural gap portions exist within the tin plating film. An external stress is reduced even if a bending process or the like are performed subsequently, because the gap portions exist within the tin plating film. Consequently, growths of whiskers accompanied by the external stress are suppressed.

### CROSS-REFERENCE TO RELATED APPLICATIONS

This application is based upon and claims the benefit of priority from the prior Japanese Patent Application No. 2006-083074, filed on Mar. 24, 2006, the entire contents of which are incorporated herein by reference.

### BACKGROUND OF THE INVENTION

1. Field of the Invention The present invention relates to a plating film and a forming method thereof suitable for a terminal of a semiconductor chip and a terminal of a connector.

2. Description of the Related Art

Tin-lead solder plating has been performed for a terminal for a connector, a lead frame for a semiconductor integrated circuit and so on. However, in recent years, utilizations of tin plating, tin-copper alloy plating, tin-bismuth alloy plating, tin-silver alloy plating, and so on which do not contain lead are examined instead of the tin-lead solder plating from a point of view of an environmental conservation. For example, an art performing the tin-copper alloy plating is disclosed in Patent Document 1 (Japanese Patent Application Laid-open No. 2001-26898).

However, when a membrane composed of the above-stated alloy not containing lead is formed, whisker-state crystals of tin called as whiskers become easy to be generated during use and so on. An electrical short circuit failure may occur between adjacent electrodes with each other if the whiskers are generated and grow. Besides, a diameter of the whisker is narrow, approximately 1 μm, a length thereof may reach 1000 μm or more. Consequently, the whiskers may be detached from the membrane to be scattered. If the whiskers are scattered, the whiskers may cause the short circuit failure inside/outside of a device.

Incidentally, an internal stress and an external stress of a plating film can be cited as one of a generation cause of the whiskers. As the internal stress, a stress due to a mismatching of a lattice constant with a base metal, a growth of an intermetallic compound caused by a diffusion reaction between the base metal (for example, Cu atom) and Sn, a gloss agent inside of the plating or the like can be cited. On the other hand, as the external stress, a stress received at the time of a bending process and a punching process performed after the plating or the like can be cited in the lead frame, and a stress received when a contact is engaged in the terminal or the like can be cited for the connector.

The internal stress can be reduced by performing mat plating or semi-gloss plating by using a plating solution in which a gloss component is extremely decreased. Besides, it is confirmed that the generation of the whiskers is suppressed by reducing the stress by performing a heat treatment at approximately 150° C. after the plating. Furthermore, it is also effective that a diffusion barrier layer composed of nickel or the like is plated to the base metal in advance to suppress the growth of the intermetallic compound.

As stated above, methods to suppress the growth of the whiskers accompanied by the internal stress exists, but a method to suppress the growth of the whiskers accompanied by the external stress is not known. Consequently, it cannot be said that a suppression of the short circuit failure and so on are sufficient because the growth of the whisker accompanied by the external stress cannot be suppressed even though the internal stress can be suppressed.

### SUMMARY OF THE INVENTION

An object of the present invention is to provide a plating film and a forming method thereof capable of effectively suppressing a growth of whiskers accompanied by an external stress.

The present inventor comes to an idea of various embodiments of the invention as shown in the following as a result of hard study to solve the above-stated problems.

A plating film according to the present invention is a plating film composed of tin or tin alloy formed on a surface of a substrate, wherein gap portions exist between crystal grains in the film.

In a forming method of a plating film according to the present invention, a substrate is immersed in a plating solution, and thereafter electrolysis of the plating solution is performed while making the substrate a cathode. At that time, a concentration of a surfactant to be added to the plating solution is set as 10 g/liter or less, and a current flowing in the cathode is set as 2.5 A/dm² or more.

### BRIEF DESCRIPTION OF THE DRAWINGS

FIG. 1 is a view showing a lead frame including a plating film according to an embodiment of the present invention;

FIG. 2 is a sectional view showing the lead frame;

FIG. 3 is a view showing an appearance of a PGA package;

FIG. 4 is a view showing an appearance of an SOP;

FIG. 5A is a view showing an appearance of a male connector;

FIG. 5B is a view showing an appearance of a female connector; and

FIG. 6 is a view showing an appearance of a USB connector.

### DETAILED DESCRIPTION OF THE PREFERRED EMBODIMENTS

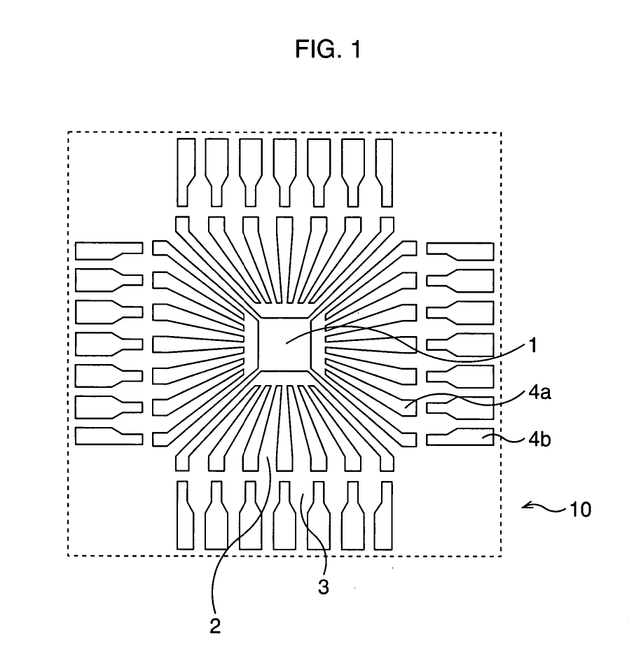

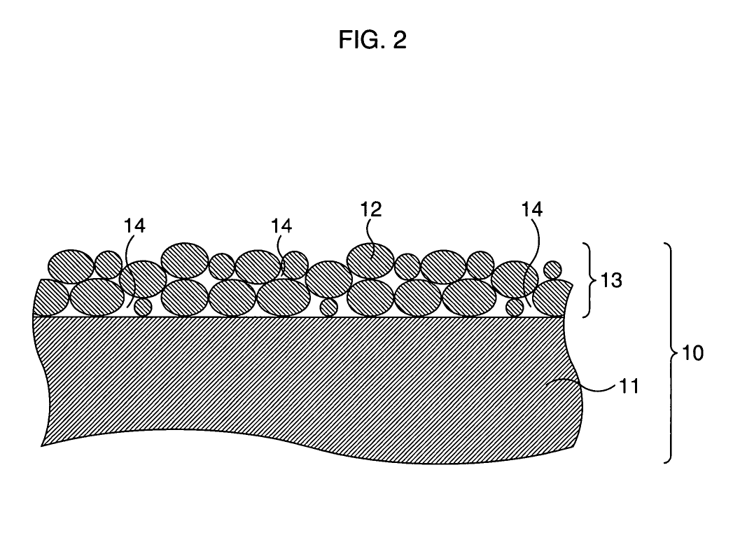

Hereinafter, embodiments of the present invention are concretely described with reference to the attached drawings. FIG. 1 is a view showing a lead frame including a plating film according to an embodiment of the present invention. Besides, FIG. 2 is a sectional view showing a cross-sectional structure of the lead frame.

A dye pad 1 on which a semiconductor chip is to be mounted is provided at a lead frame 10, plural holes 4a extending radially are formed in circumference thereof. Inner lead portions 2 are formed between adjacent holes 4a. Besides, plural holes 4b are formed at outside of the holes 4a, and outer lead portions 3 are formed between adjacent holes 4b.

Besides, as shown in FIG. 2, a tin plating film 13 composed of tin or tin alloy is formed on a front surface and a rear surface of a substrate 11 composing the lead frame 10. As tin alloy, for example, tin-copper alloy (content of copper: 2 mass %), tin-bismuth alloy (content of bismuth: 2 mass %) and the like can be cited. The substrate 11 is composed of, for example, Cu alloy or the like. Within the tin plating film 13, plural crystal grains 12 are arranged irregularly. Further, in the present embodiment, plural gap portions 14 exist within the tin plating film 13. Incidentally, in FIG. 2, a shape of each crystal grain 12 is an ellipse, but an actual shape thereof is a polygon, the one a curve is combined with a polygon, or the like.

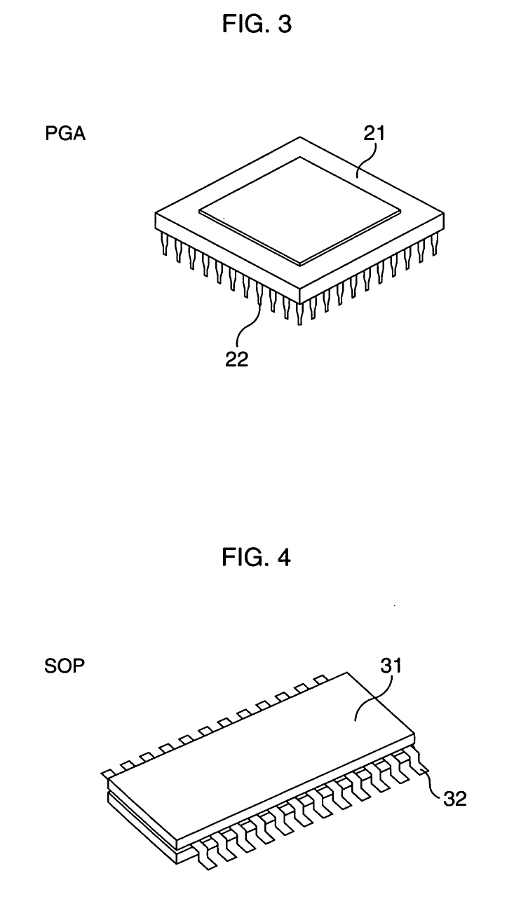

As to the lead frame 10 constituted as stated above, bonding between terminals of the semiconductor chip and the inner lead portions 2 are performed after the semiconductor chip is fixed to the dye pad 1. Subsequently, portions between the holes 4a and the holes 4b are cut. A bending process of the outer lead portions 3 and the like are performed after sealing of the semiconductor chip and the inner lead portions 2 are performed. As a result, a PGA package (Pin Grid Array) or the like can be obtained. In FIG. 3, an appearance of the PGA package is shown. In the PGA package, lead terminals 22 are extending in the same direction with each other from a housing 21 composed of ceramic or the like. Besides, an SOP (Small Out-line Package) as shown in FIG. 4 or the like can also be obtained, if a pattern of the lead frame is changed. In the SOP, plural lead terminals 32 are extending from two long edges of a housing 31 of which planer shape is rectangle.

When a conventional plating film is formed, whiskers are easy to be generated by an external stress operated at the time of the bending process. On the contrary, in the present embodiment, the external stress is reduced because the gap portions 14 exist within the tin plating film 13, even if the bending process or the like is performed. Consequently, the growths of the whiskers accompanied by the external stress are suppressed.

Incidentally, a maximum diameter of the gap portion 14 is preferable to be 50% or less of a thickness of the tin plating film 13. This is because damages may occur to the tin plating film 13 resulting from an insufficiency of a mechanical resistance for the external stress if the maximum diameter of the gap portion 14 exceeds the thickness of the tin plating film 13.

Besides, from a point of view of the mechanical resistance, if a hardness of the plating film is defined, the hardness of the plating film measured by a nanoindentation method is preferable to be 150 MPa to 400 MPa. If the hardness of the plating film is less than 150 MPa, the mechanical resistance may become insufficient, and if the hardness of the plating film is over 400 MPa, it becomes easy to be affected by the external stress.

Besides, a ratio of the gap portion 14 within the tin plating film 13 is preferable to be 5 vol % to 30 vol %. If the ratio of the gap portion 14 is less than 5 vol %, an effect to reduce the external stress may be eliminated, and if the ratio of the gap portion 14 is over 30 vol %, the resistance may become insufficient.

In an electroplating method to form the tin plating film containing gap portions as stated above, an amount of a surfactant added to a plating solution is set as 10 g/liter or less and a current density is set as 2.5 A/dm² or more, for example. If the surfactant is added more than 10 g/liter, the tin plating film to be formed becomes precise, and the gap portions are easy to go short. Besides, when the current density is set as less than 2.5 A/dm², a crystal grain diameter composing the tin plating film becomes small and the gap portions are easy to go short. In the electroplating method, the substrate (material to be plated) is made to be a cathode to perform electrolysis of the plating solution. Incidentally, as the surfactant, for example, a nonionic surfactant, a cationic surfactant, an anionic surfactant, an amphoteric surfactant and the like can be used. Examples of usable surfactants are cited in the following. However, it is not limited to these.

As the nonionic surfactant, polyoxyalkylene alkylether, polyoxyalkylene naphthylether, polyoxyalkylene bisphenol ether, polyoxyethylene polyoxypropylene block polymer, polyoxyalkylene sorbitan fatty acid ester, polyoxyalkylene glycerin fatty acid ester, polyoxyalkylene alkylamine, polyoxyalkylene alkyl phenyl formalin condensate, oxyethylene alkylamine and the like can be cited.

As the cationic surfactant, alkyl trimethyl ammonium halide, hydroxyethyl alkyl imidazoline, dialkyl dimethyl ammonium halide, alkyl dimethyl benzyl ammonium halide, alkyl amine hydrochloride, alkyl amine acetate, alkyl amine oleate, alkyl aminoethyl glycine and the like can be cited.

As the anionic surfactant, fatty acid soap series surfactant, alkyl sulfonate, alpha olefin sulfonate, alkyl diphenyl ether disulfonate, polyoxyethylene alkylether sulfuric ester salt, higher alcohol phosphoric monoester salt, polyoxyalkylene alkylether phosphoric acid (polyoxyalkylene alkylether phosphate), polyoxyalkylene phenyl ether phosphate, polyoxyethylene alkylether acetate, alkanoyl methylalanine salt, N-acyl sulfocarboxylate, alkyl sulfoacetate, sulfosuccinic monooleylamide salt and the like can be cited.

As the amphoteric surfactant, 2-alkyl-N-carboxymethyl (or ethyl)-N-carboxymethyloxyethyl imidazolynium betaine, dimethyl alkyl betaine, N-alkyl-beta-aminopropionic acid (or salt thereof), alkyl (poly) aminoethyl glycine and the like can be cited.

As tin salt or tin complex used for the tin plating process, for example, salt of inorganic acid such as tin sulfate, tin fluoroborate, tin hydrofluorosilicic acid, tin sulfamate, tin stannate, tin pyrophosphate tin and the like can be used. Besides, aliphatic sulfonate such as tin methanesulfonate, tin sulfosuccinate and the like may be used. Further, compound salt and the like having carboxyl group such as tin succinate, tin malonate, tin gluconate and the like may be used.

Besides, one kind or two or more kinds from a smoothing agent, a gloss agent, a pH buffering agent, and/or conductive salt may be added to the plating solution.

Incidentally, it is preferable to perform a cathode electrolytic degreasing process and a chemical polishing of a substrate (material to be plated) before the plating process. Furthermore, it is preferable to perform a washing of the substrate after the cathode electrolytic degreasing process and the chemical polishing. As an electrolytic degreasing agent, for example, Cleaner 160 manufactured by Meltex co. Ltd. can be used. As a polishing agent, for example, 50% CPB 40 manufactured by Mitsubishi Gas chemical company Inc. can be used.

The gap portion is not necessarily be a complete cavity but fine particles such as resin particles or ceramic particles may exist within the gap portion. For example, resin powders or ceramic powders are added to the plating solution, and these particles are to be precipitated simultaneously with a forming of the plating film to form such tin plating film. Discontinuous grain boundaries are formed within the tin plating film by dispersing these particles within the tin plating film, and the external stress is reduced. Other particles than the resin particles or the ceramic particles may be used if the external stress can be reduced as stated above.

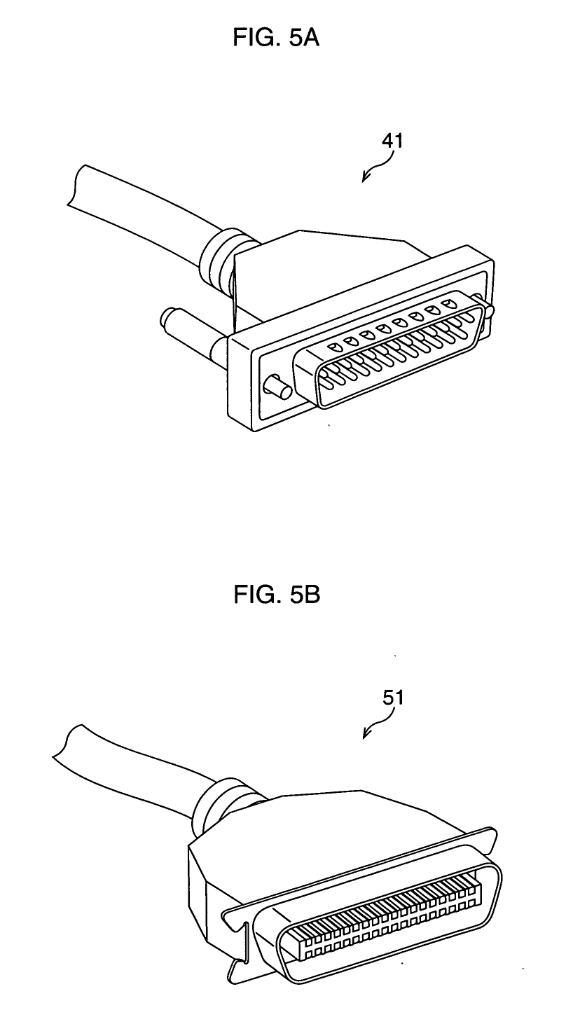

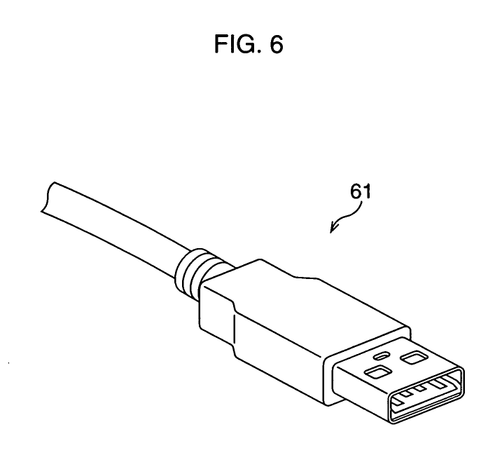

Incidentally, in the above-stated embodiment, the tin plating film is formed on the surface of the lead frame, but an object on which the tin plating film is to be formed is not limited to the lead frame. For example, it may be formed on a surface of a terminal of a connector. As the connector, for example, a male connector 41 shown in FIG. 5A, a female connector 51 shown in FIG. 5B, an USB (Universal Serial Bus) connector 61 shown in FIG. 6 and the like can be cited.

The forming of the tin plating film to the connector is performed after, for example, a bending process and the like are performed, and therefore, the external stress may not operate on the tin plating film at the time of the bending process, but the external stress may operate to the tin plating film when the connector is engaged with a destination for connection. The whiskers become difficult to be generated if appropriate gap portions as same as the above-described embodiment are formed even in such a case.

Incidentally, a thickness of a tin plating film formed on a terminal of a connector is approximately 3 μm in general. This is because a good engagement can be realized with the thickness as stated above. If the thickness of the tin plating film is approximately 3 μm, a maximum diameter of the gap portion is preferable to be approximately 1.5 μm, which is half of the maximum diameter of the tin plating film, as same as the case of the lead frame. Besides, the thickness of the tin plating film is preferable to be 2 μm to 3 μm regardless for which terminal it is used. If the thickness is less than 2 μm, there is a case when a sufficient function as a plating film (protection of a substrate and so on) can not be exerted. If the thickness is over 3 μm, variation of the thickness is easy to occur. Besides, as a plating base material, there is not a restriction in particular, and a 42 alloy material, a brass material, a phosphor bronze material, a beryllium copper material, a copper material, a nickel material and the like can be used. Furthermore, the one constituted by forming a nickel plating film, a copper plating film or the like on the surface of a substrate can be used.

Next, an examination actually performed by the present inventor is described. In this examination, a lead terminal with 40 pins made of phosphorus bronze was used as a substrate.

First, a cathode electrolytic degreasing process was performed to a substrate as a pre-process of plating. Cleaner 160 manufactured by Meltex co. Ltd. was used as an electrolytic degreasing agent. In the degreasing process, a process temperature was set at 65° C., a current density was set at 2.5 A/dm², a processing time was set for 30 seconds. After the cathode electrolytic degreasing process was completed, the substrate was washed.

Next, the substrate is chemically polished. 50% CPB40 manufactured by Mitsubishi Gas chemical company Inc. was used as a polishing agent. In the chemical polishing, a temperature of the agent was set to be approximately at a room temperature, and an immersing time was set for 20 seconds. After the chemical polishing was completed, the substrate was washed.

Subsequently, a plating process was performed for the substrate, to thereby form a tin plating film. In the plating process, the process temperature was set at 30° C., and the processing time was set for 20 seconds. Besides, the thickness of the tin plating film was approximately 3 μm. A composition of a plating process solution used in the plating process is shown in Table 1. Incidentally, methanol within the plating process solution was contained to disperse tin methane sulfonate, methane sulfonic acid, and polyoxyalkylene bisphenol ether uniformly.

TABLE 1

| | Comparative | Example | Example | Example | Example | Example | Example |
|---|---|---|---|---|---|---|---|
| | example | 1 | 2 | 3 | 4 | 5 | 6 |
| Tin Methane- | 17 | 17 | 17 | 17 | 17 | 17 | 17 |
| sulfonate (g/l) | | | | | | | |
| Methane-sulfonic | 36 | 46 | 46 | 51 | 51 | 54 | 54 |
| acid (g/l) | | | | | | | |
| Polyoxyalkylene | 20 | 10 | 10 | 5 | 5 | 2 | 2 |
| bisphenol ether (g/l) | | | | | | | |
| Methanol (g/l) | 27 | 27 | 27 | 27 | 27 | 27 | 27 |

An evaluation of the whiskers was performed as for connector lead terminals on which the tin plating films were formed. In the evaluation, the male connector and the female connector were engaged with each other and then left for 2000 hours in room temperature. Subsequently, surfaces of respective samples were observed with a microscope using a magnification of 100 power. If a whiskers was found, a detailed observation was performed by using the microscope with higher-power. The result was shown in Table 2.

TABLE 2

| | Comparative | Example | Example | Example | Example | Example | Example |
|---|---|---|---|---|---|---|---|
| | example | 1 | 2 | 3 | 4 | 5 | 6 |
| Current Density (A/dm²) | 10 | 10 | 15 | 15 | 20 | 20 | 25 |
| Gap Ratio (%) | 0 | 2 | 5 | 8 | 19 | 30 | 38 |
| Hardness (MPa) | 500 | 320 | 250 | 200 | 180 | 40 | 30 |
| Whiskers generation number | >50 | 3 | 0 | 0 | 0 | 0 | 0 |

As shown in Table 2, in the comparative example, in which the gap portions did not exist within the tin plating film, the whiskers were generated in bulk. The whiskers were also generated in the example 1 because the ratio of the gap portion was small, but the number was very small. On the other hand, in the example 6, in which the ratio of the gap portion was over 30%, the generation of the whiskers could be prevented completely, but the plating hardness was low. It can also be said that the ratio of the gap portion is preferable to be 5% to 30% from these results.

According to the present invention, the external stress is reduced by the gap portions even if the external stress operates on the plating film. Consequently, a growth of the whiskers accompanied by the external stress can be suppressed.

What is claimed is:

1. A plating film composed of tin or tin alloy formed on a surface of a substrate, gap portions existing between crystal grains in said film.

2. The plating film according to claim 1, wherein a ratio of said gap portions is from 5 mass % to 30 mass % of said plating film.

3. The plating film according to claim 1, wherein a maximum diameter of said gap portion is 50% or less of a thickness of said plating film.

4. The plating film according to claim 1, wherein hardness measured by a nanoindentation method is from 150 MPa to 400 Mpa.

5. The plating film according to claim 1, wherein a thickness is from 2 μm to 3 μm.

6. The plating film according to claim 1, wherein fine particles exist within said gap portions.

7. An electronic component, comprising:
a substrate;
a plating film composed of tin or tin alloy formed on a surface of said substrate, gap portions existing between crystal grains in said plating film.

8. The electronic component according to claim 7, wherein a ratio of said gap portions is from 5 mass % to 30 mass % of said plating film.

9. The electronic component according to claim 7, wherein a maximum diameter of said gap portion is 50% or less of a thickness of said plating film.

10. The electronic component according to claim 7, wherein hardness of said plating film measured by a nanoindentation method is from 150 MPa to 400 Mpa.

11. The electronic component according to claim 7, wherein a thickness of said plating film is from 2 μm to 3 μm.

12. The electronic component according to claim 7, wherein fine particles exist within said gap portions.

13. A forming method of a plating film composed of tin or tin alloy, comprising:
immersing a substrate in a plating solution, a concentration of a surfactant to be added to said plating solution being set as 10 g/liter or less; and
performing electrolysis of said plating solution while making said substrate a cathode, a current flowing in said cathode being set as 2.5 A/dm² or more.
